(19) United States
(12) Patent Application Publication
(10) Pub. No.: US 2019/0125131 A1
(43) Pub. Date: May 2, 2019

(54) FRYER AND ASSOCIATED HEAT EXCHANGER

(71) Applicant: ILLINOIS TOOL WORKS INC., Glenview, IL (US)

(72) Inventors: Kacy W. Denning, Charlotte, NC (US); Craig D. Burnett, Concord, NC (US); Carlos M. Franco-Pulgarin, Rock Hill, SC (US)

(21) Appl. No.: 16/175,103

(22) Filed: Oct. 30, 2018

Related U.S. Application Data
(60) Provisional application No. 62/579,410, filed on Oct. 31, 2017.

(51) Int. Cl. A47J 37/12

(52) U.S. Cl. CPC A47J 37/1247

(57) ABSTRACT

A fryer unit includes a fryer vat defining a volume for receiving oil to be heated for cooking. A heating system is provided for heating oil in the volume. The heating system includes at least one gaseous fuel burner and at least one heat exchange tube, the heat exchange tube passing through the volume such that an external surface of the heat exchange tube will be in contact with oil in the volume. The heat exchange tube defines an internal passage through which heated combustion gases of the gaseous fuel burner can pass, and a baffle is positioned within the internal passage for enhancing heat transfer from the combustion gases to the external surface of the heat exchange tube.

### CROSS-REFERENCES

This application claims the benefit of U.S. provisional application No. 62/579,410, filed Oct. 31, 2017, which is incorporated herein by reference in its entirety.

### TECHNICAL FIELD

The present invention relates generally to deep-fat fryers and, more particularly, to a deep-fat fryer heat exchange system.

### BACKGROUND

A typical deep-fat fryer will include a fryer vat containing a heated bath of cooking oil. The cooking oil is adapted to receive baskets of food products such that the food products will be immersed within and cooked by the heated cooking oil. Such fryers include a heat exchanger, which may take the form of one or more in vat heat exchange tubes through which combusted gases pass to deliver heat to the oil through the tube walls.

It would be desirable to provide a fryer and associated heat exchange tube and system that effectively and efficiently heats oil in the fryer vat.

### SUMMARY

In one aspect, a baffle is utilized as primary heat transfer device installed within one or more burner tubes of a fryer. The baffle(s) restrict the flow of heated combustion gases deflecting the gases within the tube(s) which are in direct contact with the cooking substrate (oil). The objective is to increase the thermal transfer of the combustion gas heat energy into the tube walls to increase the cooking efficiency of the fryer. The baffle configuration may include multi angled profiled fins which also have air pass holes on each fin to enhance airflow and maximize heat transfer.

In another aspect, a fryer unit includes a fryer vat defining a volume for receiving oil to be heated for cooking. A heating system is provided for heating oil in the volume. The heating system includes at least one gaseous fuel burner and at least one heat exchange tube, the heat exchange tube passing through the volume such that an external surface of the heat exchange tube will be in contact with oil in the volume. The heat exchange tube defines an internal passage through which heated combustion gases of the gaseous fuel burner can pass, and a baffle is positioned within the internal passage for enhancing heat transfer from the combustion gases to the external surface of the heat exchange tube.

In one implementation the fryer vat includes three burner tubes and there is one baffle per burner tube.

In one implementation the baffle is inserted from the rear of the fryer unit or rear of the baffle tube, which baffle tube extend from a front side of the vat to a rear side of the vat. Two fingers/flanges on the rear of the baffle catch the rear of the burner tube and a front finger/flange is pulled over to catch a flange face on the front of the burner tube.

In one implementation, flow through the tube is primarily a spiral throughout the tube.

In one implementation, each burner tube profile is oval-shaped or elongated slot-shaped with end curves and linear side sections, and the longer dimension of the profile is oriented substantially vertically in the vat. Each burner may be formed by two like burner segments, each with a curved end and a straight side, that are welded together.

In one implementation each baffle has a plurality of fin sets arranged sequentially along a flow path of the internal passage of the heat exchange tube. The fin sets may include a progressively increasing angle of departure from an elongated axis of the heat exchange tube. At least one or more initial sets of fins may be angled in a direction with the flow direction from front to rear of the heat exchange tube. At least one or more downstream sets of fins may be oriented perpendicular to the flow direction.

In one implementation each baffle has a plurality of fin sets arranged sequentially along a flow path of the internal passage of the heat exchange tube. Each fin set may include an upper fin and a lower fin, both of which angle away from a central plate portion of the baffle. Each fin set may further include a left fin and a right fin, each of which departs from a common axial position along a length of the central plate portion. In one implementation, each fin set includes one upper fin at one side of the central plate portion and one lower fin at an opposite side of the plate portion.

In one implementation each baffle is formed by a single piece of plate material cut/stamped and bent to final baffle shape.

In one implementation a bottom edge part of a central plate portion of the baffle contacts a lower internal surface of the internal passage of the heat exchange tube.

### BRIEF DESCRIPTION OF THE DRAWINGS

FIG. 1 shows a perspective view of a fryer;

FIG. 2 shows a partial side elevation of the fryer;

FIG. 3 shows a perspective view of a baffle;

FIG. 4 shows a side elevation of the baffle;

FIG. 5 shows a top plan view of the baffle;

FIG. 6 shows a rear perspective of baffles within heat exchange tubes;

FIG. 7 shows a front perspective of a baffle within a heat exchange tube;

FIG. 8 shows a top plan view of flow within heat exchange tubes; and

FIG. 9 shows a side elevation of flow within a heat exchange tube.

### DETAILED DESCRIPTION

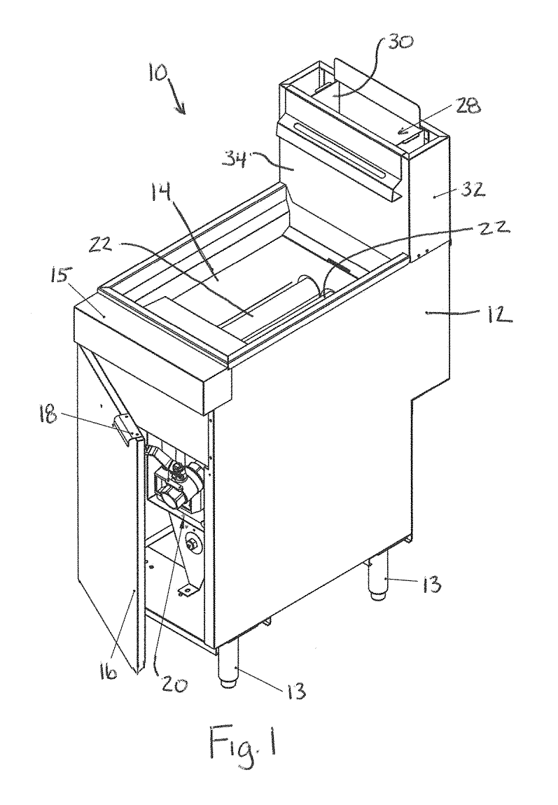

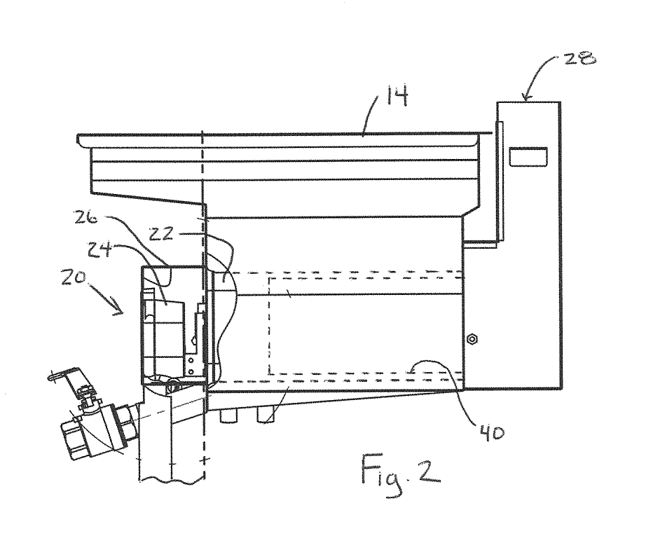

Referring to FIGS. 1 and 2, a fryer 10 includes a housing 12 that supports an open-top vat 14 having front, rear, left, right and bottom side wall portions. Legs 13 support the housing and a front shelf area 15 is provided. The vat 14 walls may, for example, be formed of stainless steel or aluminum sheet metal that is formed and welded. A typical volume for the vat may be between about 5 to 11 gallons (e.g, typically about 40 to 90 pounds of oil). An access door 16 and handle 18 at the front of the fryer moves between open and closed positions to permit access to internal components, including the front side of the vat and portions of a heating system 20 associated with the fryer vat for heating oil within the fryer vat.

The fryer housing structure to which the vat is attached may include edge portions extending upward from the right and left sides of the vat, a front portion 15 extending laterally forward of the front of the vat to an upwardly extending front edge portion, and a back portion including an upwardly extending rear wall 34 formed by part of the chimney shell 32. Here, the rear wall 34 extends upward to a height well above the height of the left, right and front edge portions. Additional housing structure and/or support frame structure may be associated with the bottom portion of the fryer vat as well.

The oil heating system 20 includes one or more (here three) heat exchange tubes 22, each with an associated gaseous fuel burner 24. The heat exchange tubes 22 extend from a front side of the fryer vat to a read side of the fryer vat, and may be integrated with the fryer vat as a unit, such as where a front edge of each heat exchange tube is welded to the front wall of the fryer vat and a rear edge of each heat exchange tube is welded to the rear wall of the fryer vat. The heat exchange tubes 22 are immersed in oil within the vat and therefore heat exchange occurs between combustion gasses in the heat exchange tubes and the oil in the vat through the walls of heat exchange tubes. A burner casing 26 covers the burners. During frying operations, when oil in the vat is being heated, gaseous fuel is fed to the burners and combusted at the front of each heat exchange tube, and the combustion gases then traverse the length of the tubes (e.g., from left to right in the side view of FIG. 2) toward the rear side of the fryer, where the combustion gases then move up through an exhaust chimney 28 formed by a liner 30 and shell 32. Each heat exchange tube 22 includes an internal baffle 40 (shown schematically in FIG. 2) that is configured to promote a flow within the tube that enhances heat exchange from the combustion gases to the oil within the vat.

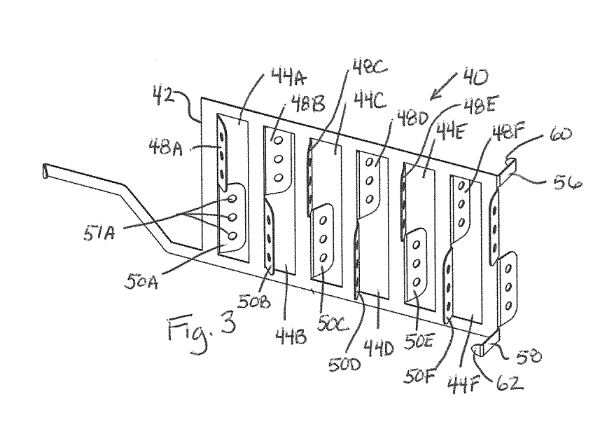

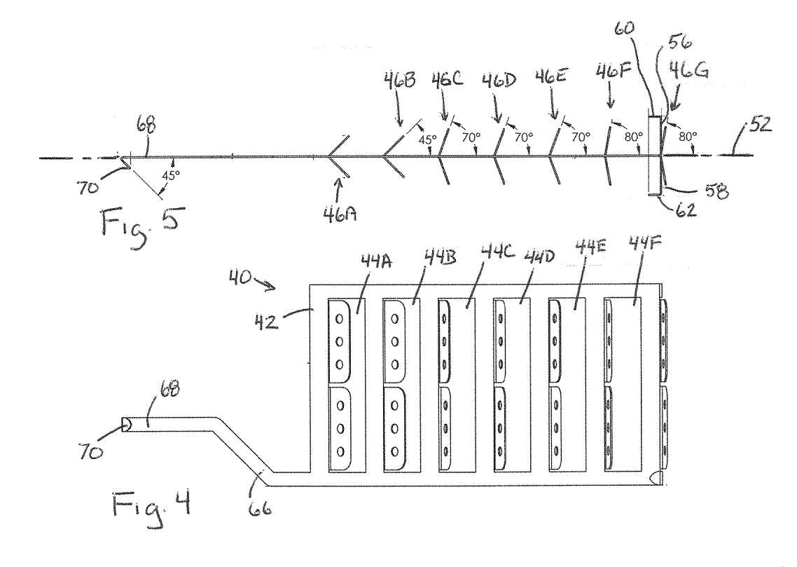

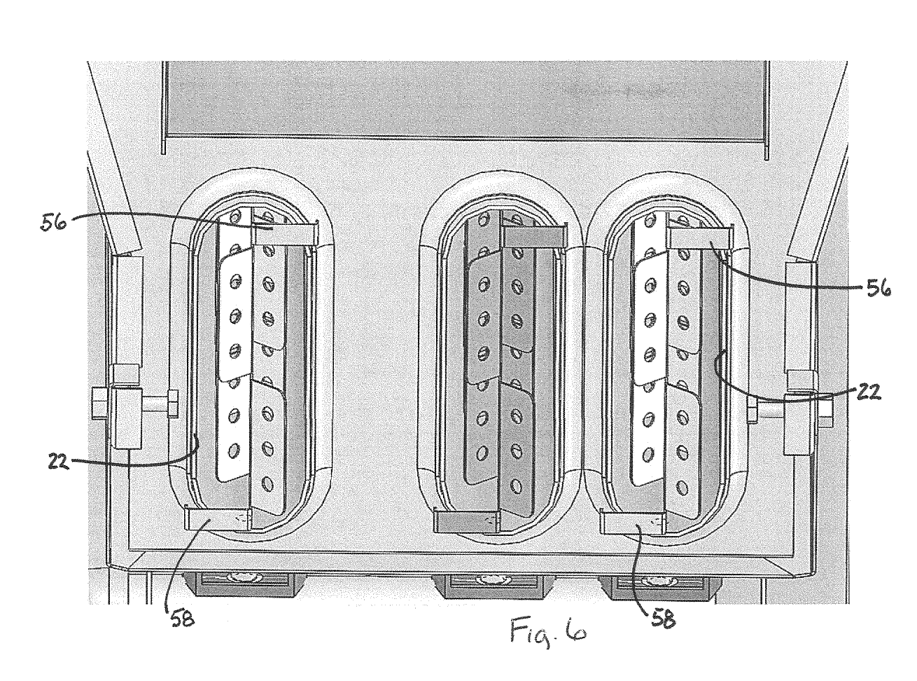

Referring to FIGS. 3-5, in one implementation the baffle 40 is formed by a central frame or plate structure 42, which here is disposed centrally along a lateral width of the heat exchange tube. The central frame structure 42 defines a plurality of openings 44A-44F, and each opening includes a set of fins or flaps 46A-46F extending laterally and rearwardly from the forward edge of the opening. Each fin set is formed by an upper fin 48A-48F and a lower fin 50A-50F, both of which angle away from the central plate portion of the baffle. Each fin includes multiple openings (e.g., openings 51A). Here, the openings 51A are spaced apart vertically along the height of the fin are generally centered on the width of the fin. In the illustrated embodiment, the fins all have substantially the same configuration of openings, but embodiments in which fins have different opening sizes and/or position are possible.

As shown, in the case of each fin set, one of the upper fin or the lower fin extends to one side of the central plate portion 42 and the other of the upper fin or the lower fin extends to the other side of the central plate portion 42. Here, fin extension direction alternates from opening to opening (i.e., the upper fin of any given opening extends to one side of the central plate portion 42 but the upper fin(s) of the adjacent opening(s) in the opening sequence extend to the other side of the central plate portion, and similarly for the lower fins).

Generally, fin sets toward the rear of the baffle plate structure 52 (e.g., fin sets 46E and 46F) depart from the plane or axis 52 defined by the central plate structure 52 with a higher departure angle than fin sets toward the front of the plate structure 52 (e.g., fin sets 46A and 46B). Here, fin sets 46A and 46B have the same angle of departure angle (e.g., about forty-five degrees, such as between thirty-five and fifty degrees), fin sets 46C-46E have the same departure angle (e.g., about seventy degrees, such as between sixty-five degrees and seventy-five degrees) and fin set 46F has the highest departure angle (e.g., about eight degrees, such as between seventy-five and eighty-five degrees). Here, an additional fin set 46G is located at the rear edge of the central plate structure 52 and includes fins with a departure angle that is the same as that of fin set 46F.

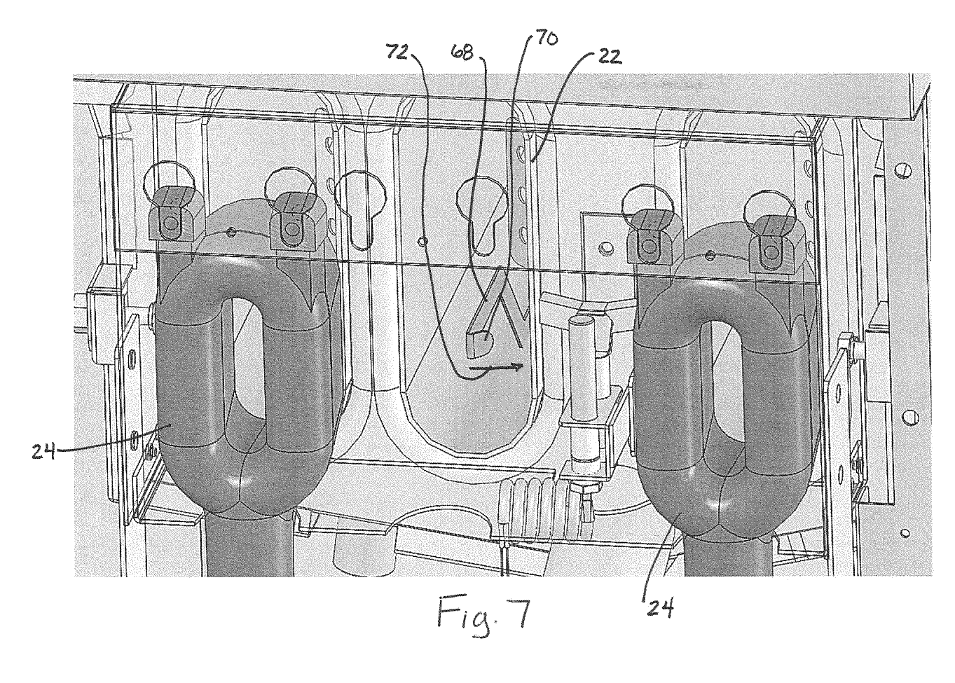

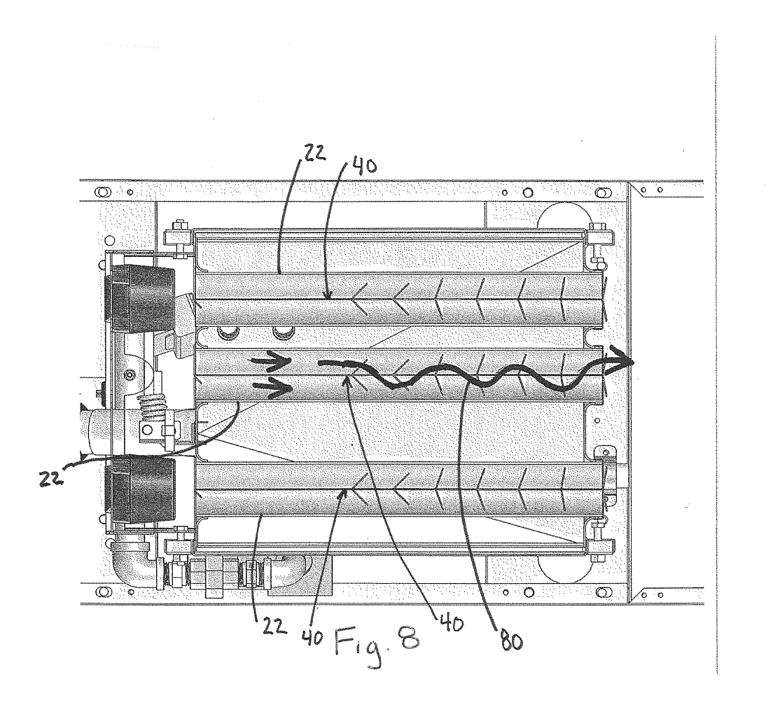

In the illustrated embodiment, the baffles 40 are inserted into the respective tubes 22 from a rear of the tube. In this regarding, each baffle 40 includes an upper finger or flange 56 and a lower finger or flange 58 that extend laterally from the rear edge of the central plate 52. Each finger or flange extends in a direction substantially perpendicular to the central plate plane or axis 52 and includes a respective end segment 60, 62 that is turned forward to run substantially parallel to the plane or axis 52. As best seen in FIG. 6, the fingers or flanges 56 and 58 catch the rear end of the heat exchange tube 22 when the baffle is inserted in the tube 22, and thereby define a correct axial position of the baffle within the tube 22. The bottom edge of the central plate portion 52 of the baffle may sit on the lower surface of the heat exchange tube to define the correct vertical position of the baffle within the tube. One or more side fingers or tabs could also be incorporated for lateral positioning. The illustrated baffle also includes a forward extending arm 66 that forms a front finger or flange 68 with a side tab 70. As seen in FIG. 7, where the middle tube 22 is shown without the burner 24 present, the front finger or flange 68 can be pulled laterally over (per arrow 72) to engage and catch the front edge or flange of the heat exchange tube 22, thereby securing the baffle in position within the tube. The finger 68 could also be configured to engage with part of the burner 24. In an alternative embodiment, the front finger or flange could be eliminated, and the baffle secured within the tube 22 by, for example, movable tabs at the rear side of the fryer vat that overlap the fingers or flanges 56 and 58. In another alternative, the fingers or flanges 56 and 58 could be but welded to the rear of the heat exchange tube 22 or to the rear wall of the fryer vat.

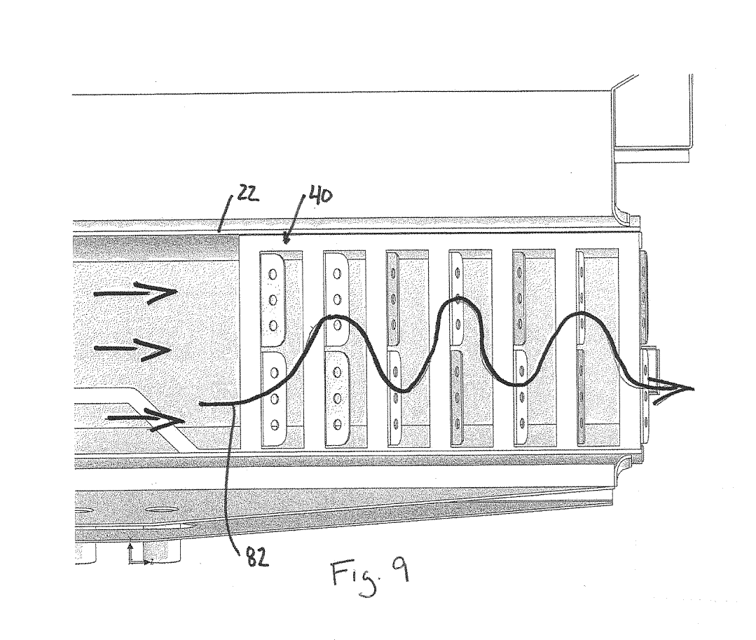

As mentioned above, the baffle 40 of each tube is configured to promote a flow within the tube that enhances heat exchange from the combustion gases to the oil within the vat. With the baffle configuration described above, combustion gas flow through the heat exchange tube 22 is primarily a spiral flow throughout the heat exchange tube. In this regard, reference is made to FIGS. 8 and 9, which show top plan and side elevation schematic views of the baffles 40 within the tubes 22. The primary flow path of the combustion gases is represented by arrows 80 and 82. As suggested by the arrows, the primary flow moves back and forth laterally through the openings of the central plate portion (per FIG. 8) and also repeatedly moves up and down along the height of the tube and central plate portion (per FIG. 9), thereby creating an overall primary flow that spirals within the tube, at least along the axial portion of the tube where the central plate portion is positioned. This spiral flow, caused by the openings and corresponding fin configuration and orientation, materially enhances heat transfer, thereby improving overall efficiency of the fryer.

It is to be clearly understood that the above description is intended by way of illustration and example only, is not intended to be taken by way of limitation, and that other changes and modifications are possible.

What is claimed is:

1. A fryer unit, comprising:
a fryer vat defining a volume for receiving oil to be heated for cooking;
a heating system for heating oil in the volume, the heating system including at least one gaseous fuel burner and at least one heat exchange tube, the heat exchange tube passing through the volume such that an external surface of the heat exchange tube will be in contact with oil in the volume, the heat exchange tube defining an internal passage through which heated combustion gases of the gaseous fuel burner can pass, and a baffle within the internal passage for enhancing heat transfer from the combustion gases to the external surface of the heat exchange tube.

2. The fryer unit of claim 1 wherein the heat exchange tube extends from a front side of the fryer vat to a rear side of the fryer vat, and the baffle is inserted from a rear of the heat exchange tube.

3. The fryer unit of claim 2 wherein at least one finger or flange at a rear of the baffle catches a rear side of the heat exchange tube to axially position the baffle within the heat exchange tube.

4. The fryer unit of claim 2 wherein at least one finger or flange of the baffle engages a front edge of the heat exchange tube or a flange on the gaseous fuel burner to secure the baffle within the heat exchange tube.

5. The fryer unit of claim 1 wherein the baffle is configured such that combustion gas flow through the heat exchange tube is somewhat of a spiral along at least a portion of the heat exchange tube.

6. The fryer unit of claim 1 wherein the baffle includes a plurality of fin sets arranged sequentially along part of an axial length of the internal passage of the heat exchange tube, each fin set formed by at least two fins.

7. The fryer unit of claim 6 wherein at least one fin set toward a rear of the baffle departs from a plane defined by the central portion of the baffle with a first departure angle and at least one fin set toward a front of the baffle departs from the plane with a second angle, where the second angle is smaller than the first angle.

8. The fryer unit of claim 6 wherein each fin set extends both laterally and rearwardly from a central portion of the baffle.

9. The fryer unit of claim 6 wherein each fin set includes an upper fin and a lower fin, and both the upper fin and the lower fin angle away from a central portion of the baffle.

10. The fryer unit of claim 9 wherein, for each fin set, one of the upper fin or the lower fin is extends to a first lateral side of the central portion and the other of the upper fin or the lower fin is extends to a second lateral side of the central portion, wherein the second lateral side is opposite the first lateral side.

11. The fryer unit of claim 9 wherein, for each of at least multiple fin sets, each fin departs from a front side of a respective opening located in the central portion of the baffle.

12. The fryer unit of claim 6 wherein a bottom edge part of a central plate portion of the baffle contacts a lower internal surface of the internal passage of the heat exchange tube to define a vertical position of the baffle within the heat exchange tube.

13. The fryer unit of claim 5 wherein each fin includes multiple through openings.

14. The fryer unit of claim 1 wherein the baffle includes central plate portion defining a plurality of through openings spaced apart axially along the central plate portion, wherein the baffle includes a plurality of fins, wherein each opening includes at least one associated fin that extends laterally and rearwardly from a front edge of the opening, wherein the fins cause a primary flow of combustion gases to move laterally back and forth through the openings as the combustion gases travel along the central plate portion.

15. The fryer unit of claim 14 wherein the fins cause the primary flow of combustion gases to remove repeatedly up and down along as the combustion gases travel along the central plate portion.
